(19) United States
(12) Patent Application Publication
(10) Pub. No.: US 2005/0100708 A1
(43) Pub. Date: May 12, 2005

(54) Potters decorating tool

(76) Inventor: W. Richardson McKinney, Appleton, WI (US)

Correspondence Address: W. RICHARDSON MCKINNEY, 825 N. CANTERBURY DR., APPLETON, WI, 54915, US

(21) Appl. No.: 10/981,161

(22) Filed: Nov. 3, 2004

Related U.S. Application Data
(60) Provisional application No. 60/517,658, filed on Nov. 6, 2003.

(51) Int. Cl. B32B 3/10

(52) U.S. Cl. 428/131; 428/195.1

(57) ABSTRACT

The invention is a tool to aid in rapidly applying geometric decorations to pottery. The tool is an operatively transparent sheet marked with intersecting lines. There are holes at the intersections of the lines through which the pottery may be marked.

The inventor wishes to claim the benefit of the filing date of provisional application No. 60/517,658, filed Nov. 6, 2003.

### BACKGROUND OF THE INVENTION

One of the pleasures for the artist/craftsman working in clay is that clay objects can be decorated in a multiplicity of ways during any stage in their creation. Examples of common decorating techniques for thrown pottery include glazing, faceting, trimming, application of slip, sprigging, and incising. In addition, objects produced on a potters wheel are necessarily round, but a potter may wish to alter the round object into another shape, for example oval or square. This can be done by the potter manipulating the clay at the time of the object's creation, when the clay is plastic, or it can be done by cutting the clay when it has dried to a self-supporting consistency (leather-hard stage).

Decoration and alteration made while the clay is still plastic must be done with dispatch. Clay dries on standing and may become no longer suitable for a particular technique. While free-hand decoration or alteration can be done quickly, geometrical decoration or alteration can present unexpected problems. Human beings are extremely sensitive to regular patterns and quickly detect mistakes in what should be regular patterning. For example, the spout, lid, and handle of a teapot must be perfectly aligned or the teapot will “look funny” and will not be acceptable to a purchaser. Similarly, a plate divided into sixths with slip decoration will “look funny”, and be unsaleable, if the decoration is not perfectly regular. As a further example, a shallow thrown bowl (round) may be altered into a box (square) by pulling/pushing the sides. When perfectly done, the box is very attractive and can bring a fair price; but when imperfectly done, the product “looks funny” and cannot be sold.

Despite the difficulties of its manufacture, geometric decoration is very popular and, in the case of articles with features that must be aligned, necessary. Potters who use geometric decoration prepare specialized templates so that the decoration or alteration can be done quickly and accurately. Potters using such templates must prepare individual templates not only for each article (e.g., bowl, cup, platter, teapot), but also for each size of the article, and each pattern to be used. A high level of skill is required to repeatedly prepare articles of an identical size and shape so that the templates will be useful. It is also quite time consuming to make and use so many templates.

It would be desirable to have a system that would allow the rapid and precise decoration and/or alteration of any clay article at any time during its manufacture. After much trial, the inventor has developed such a system.

### SUMMARY OF THE INVENTION

The invention is a system to assist in the decoration or alteration of thrown pottery. In one embodiment, the invention is a transparent or translucent self-supporting sheet, marked in two intersecting directions. At the intersection of each mark, there is a hole through the sheet that is less than inch in diameter. These holes are suitable for inserting a potters' needle tool to prick the clay. The holes produced by the needle tool can be used by the potter to quickly and precisely guide in altering and/or decorating the clay object.

In another embodiment, the invention is a transparent or translucent self-supporting sheet, marked with a series of concentric circles and radial dividing lines. Each line begins at the innermost circle and extends to the outermost circle. At the intersection of every circle and line, there is a hole less than 1/4 inch in diameter or, more preferably, less than 1/8 inch in diameter. These holes are suitable for inserting a potters' needle tool. In a preferred embodiment, there are sets of lines dividing the circles into equal increments. The sets of lines differ by the number of increments. For geometric decoration of pottery, increments of 2, 3, 4, 5, 6, 7, 8, 9, and 10 equal portions are useful. To prevent confusion due to an excessive number of divisions, it may be desirable to make two or more of the “decorating disks”, each with a portion of the sets. For example, a single decorating disk may contain either lines showing even divisions of 4, 6, 8, and 10 equal portions or lines showing odd divisions of 3, 5, 7, and 9 equal portions.

In another embodiment, the invention is a method for providing a system to rapidly and precisely apply geometric decoration to a clay object. The system comprises a decorating disk and instructions for its use to either alter or geometrically decorate a clay object. The disk may be used over the object to be marked, under the object to be marked, or within the object to be marked, depending on the type of object and the artistic intent of the potter.

### BRIEF DESCRIPTION OF THE DRAWINGS

FIG. 1 is a line drawing of a decorating disk with even divisions.

FIG. 2 is a line drawing of a decorating disk with odd divisions.

FIGS. 3, 4, 5, and 6 are photographs showing the decorating disk in use.

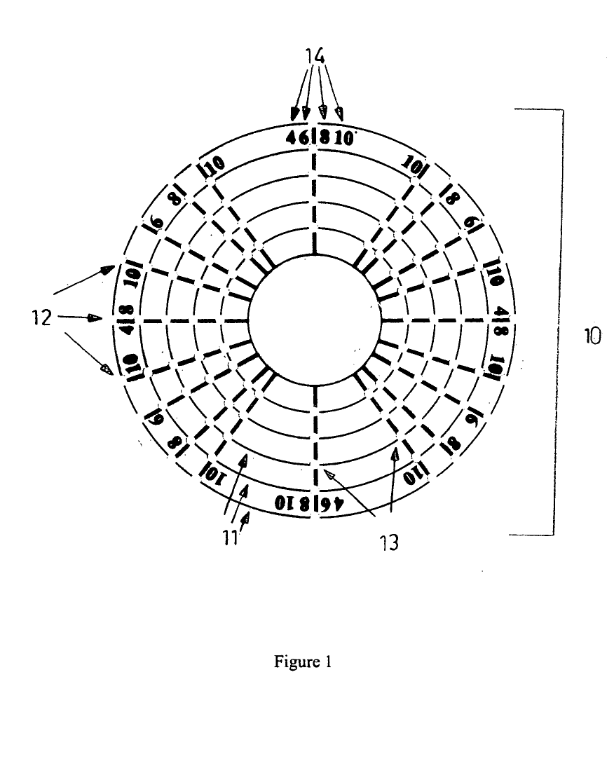

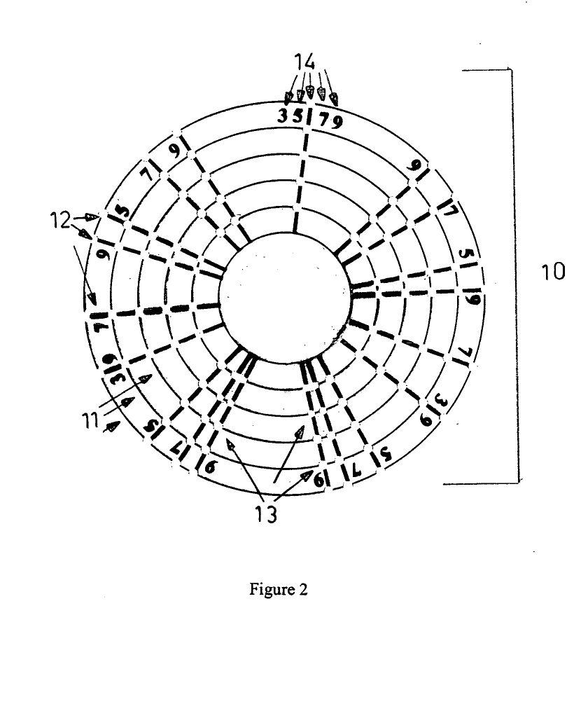

### DETAILED DESCRIPTION OF THE PREFERRED EMBODIMENTS

The terms used in this description have the meaning customary to the art of pottery. The following definitions are drawn from the glossaries and the texts of The Craft And Art Of Clay, Susan Peterson (Prentice Hall, Englewood Cliffs, N.J., 1992) and The Potter's Guide To Ceramic Surfaces, Jo Connel (Krause Publications, Iola, Wis.; 2002).

Alter: to change the shape of a clay object originally thrown circular on a potter's wheel.

Clay: A fine-grained earth materials formed by the decomposition of igneous rock. When combined with water, clay is plastic enough to be shaped.

Facet: to use a tool to cut pieces away from a thrown object, giving it an angled appearance.

Glaze: glassy melted coating developed by chemicals and heat on a clay or metal surface.

Incising: to cut lines into a piece of formed clay for decorative purposes.

Leather-hard: clay that has dried to a stiff, leather-like consistency. Some techniques, such as creating foot rings on the bottom of a thrown object or attaching handles and/or spouts, must be done at this stage.

Plasticity: workability; clay is the only natural material having real plasticity, meaning the ability to form into any shape, and to get progressively harder in the same shape on being fired to 1300 F and above.

Slip: a suspension of ceramic materials in water.

Slip Trailing: a process in which thick slip is applied to a thrown piece through a nozzle. The process results in raised lines of clay. The lines may be the same or a contrasting color.

Sprigging: pressing clay into a shallow mold then removing it from the mold while still damp creates a sprig, which is then applied to a piece of pottery for decorative purposes.

Throwing: clay is placed on a rotating potter's wheel and formed by hand in conjunction with centrifugal force.

Trimming: at the leather-hard stage, pots are returned to the potters wheel and a metal tool used to pare off excess, cut details, and refine the shape.

In one embodiment, the invention is a self-supporting operatively transparent sheet marked in two dimensions and with holes (13) at the intersections of the two-dimensional markings suitable for inserting a potters' needle tool through the sheet to mark a clay object. Operatively transparent means that that the thrown clay article can be seen through the sheet. The sheet may be transparent, that is, have an index of refraction that exactly matches that of air, or may be translucent, that is, there is some scattering of light by the sheet, but when the sheet is placed above an object to be marked, the object can be clearly seen.

Self-supporting means that the sheet will not excessively flex, bow, or flop in use. However, it is desirable that the sheet be sufficiently flexible that it can be deliberately flexed by the potter to match the shape of the article to be marked. Plastic is a suitable material to use in making the sheet. Desirable plastics include polystyrene, mylar, polyesters, and polyolefins. In the preferred embodiment, the sheet is 3/32 inch thick mylar. The two dimensional marking could be a square grid or a particular two-dimensional shape, such as a triangle, a circle, or an oval. The markings themselves could be applied by printing or engraving. Alternatively, the markings could be thickened areas of the sheet (ribs). In a particularly preferred embodiment, the markings are printed onto the sheet.

In another embodiment, the invention is a self-supporting operatively transparent sheet marked with concentric circles (11) and radial lines (12). There are holes (13) through the sheet at the intersection of the circles and lines. The markings on the sheet can be applied by printing, engraving, or can be molded into the sheet. Concentric circles are particularly apt for thrown pottery since thrown pottery is necessarily round because of the way it is formed. The concentric circles allow the user to quickly center the grid over the piece to be decorated or altered so that the marks of the needle tool will be in the correct places to quickly and precisely guide the potter in decorating or altering the clay object. Preferably, the radial lines are in sets that show equal divisions. For instance, one set would divide the circles into fourths, another into fifths, another into sixths, another into sevenths, etc. Some lines will overlap, at least in part, such as thirds and sixths or fourths and eights. Because a multiplicity of lines on a single sheet could be confusing, the inventor proposes to use at least two sheets, one with odd divisions (3, 5, 7, 9) and another with even divisions (4, 6, 8, 10). In a preferred embodiment each set of lines would be begin at a common starting line and be differentiated by a further marking, such as a printed numeral (14) to show the division. The radial lines could be further differentiated by differing colors for each division pattern. While the maximum number of divisions mentioned is 10, this is an arbitrary number and the only true upper limit is the number of divisions that can be clearly indicated. The inventor recognizes that an alternative embodiment would have the divisions so arranged that no two lines overlap by carefully choosing the starting point for each set of divisions.

Because fresh clay is soft, the preferred marking technique of all potters is to prick the clay with a needle tool, leaving a small hole. A potters needle tool is a needle-like piece of metal mounted in a grip. Clay can be marked with a needle until it has been fired. The small holes left by a needle tool can be easily smoothed over. Alternatively, the small holes can be covered by glaze. Alternatively, the holes will shrink and typically disappear during firing, even if no effort is made to remove or hide them. There are holes (13) through the decorating tool sheet at the intersection of the grid markings to allow a needle tool to mark the underlying piece of clay. The holes need to be less than 1/4 inch in diameter, preferably they are less than 1/8 inch in diameter. Holes that are too large would allow such variation in the placement of the needle tool that the markings would not be sufficiently precise. The inventor believes that holes over 1/4 inch in diameter would be too large. Holes too small to allow the insertion of a needle tool would render the decorating tool useless. Holes less than 1/32 inch in diameter are considered by the inventor to be too small.

The invention is also a method for providing a system to rapidly and accurately mark clay objects for decoration or alteration. The system provided comprises using the decorating disk described above in combination with a clay object in order to rapidly and precisely identify where to either apply a geometric decoration or alter the clay object into a regular geometric shape. The decorating disk may be used above a thrown clay object to make marks beneath. Alternatively, the disk may be placed beneath the object in order to make markings low on the object, especially for an object that has a curve that hides the bottom when viewed directly from above. Alternatively, the decorating disk may be placed inside an object in order to mark the clay for geometric decoration or alteration. By marking a line on the substrate on which the clay object is placed, the decorating disk can be aligned with the substrate and used both above and below the same clay object.

The utility of the decorating tool is shown in the following examples.

### EXAMPLE 1

### An Alteration of a Leather Hard Clay Object

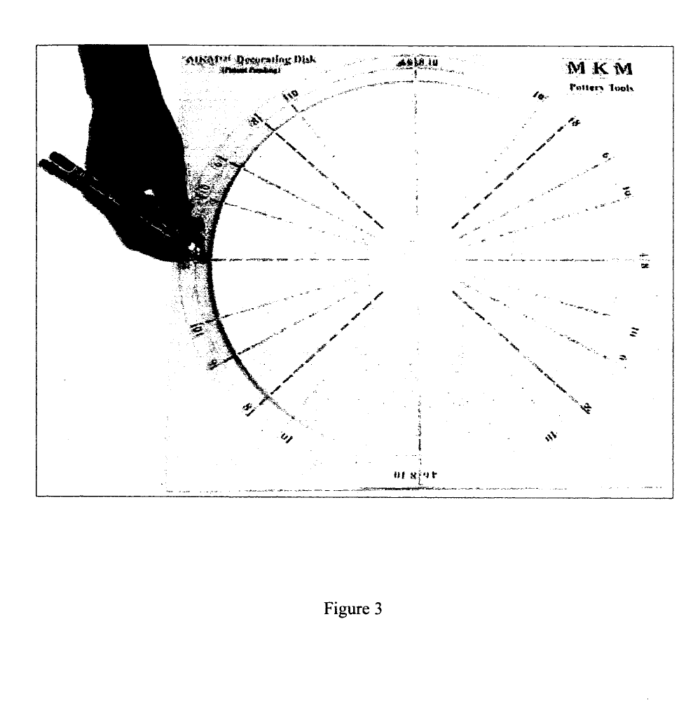

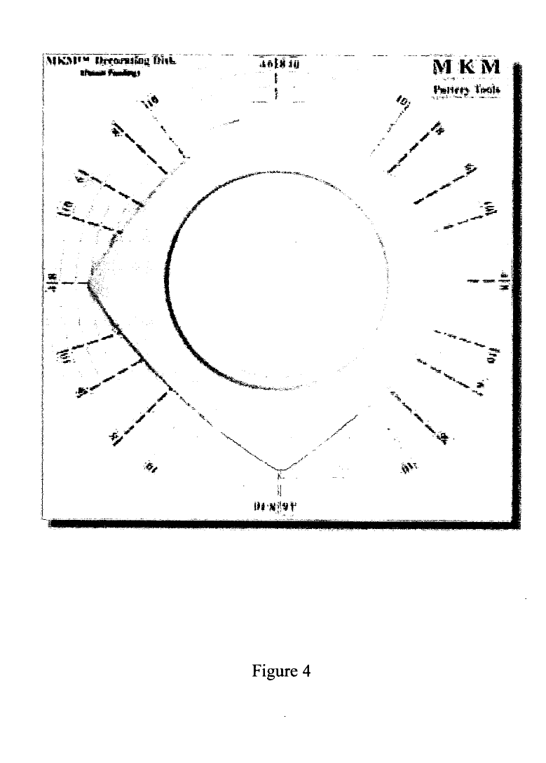

A 12″ plate was prepared using the standard techniques of a potter. At the leather-hard stage when the clay is still somewhat soft, after trimming and forming a foot-ring, a decorating disk marked with concentric circles and radial lines was placed above the plate. Using the concentric rings, the disk was quickly centered above the plate. Selecting the set of 4 parts dividing lines, the potter marked the plate as close as possible to the rim with a needle tool through the appropriate holes in the 4 parts dividing lines (FIG. 3). Removing the disk, the potter then used a knife to cut between the marks, thus turning a round plate into a precisely square plate. FIG. 4 shows a plate on the decorating disk after the cutting process. The technique shown in this example can be used to alter any clay object into any number of precisely defined sides at any stage in its production until the object is fired and can no longer be altered.

### EXAMPLE 2

### Faceting a Wet Clay Object

A 10 inch tapered cylinder intended as a vase is formed using the standard techniques of a potter. When the clay is still moist but firm enough to handle, the cylinder is centered over a decorating disk marked with concentric circles and radial lines using the concentric circles on the decorating disk. Marks are then made in the base of the cylinder using the needle tool at the 10ths radial divisions. The decorating disk is then moved to the top of the cylinder and again centered on the object using the concentric circles. Marks are then made through the disk using the holes located at the intersection of the circles and radial lines. Since the intention is to make a regular faceted spiral, the top and bottom marks are offset. The decorating disk is then removed. Using a wire tool (a length of metal wire connecting two wooden handles) and moving the hand in a downward motion, slices of wet clay are sliced off the cylinder between the top and bottom guide marks, leaving a spiraling flat surface on the face of the cylinder. Moving around the object, more slices of clay are removed from the cylinder until the entire surface, or some part of that surface, is covered with spiraling facets. The marks from the decorating disk are essential to keep the width and spiral angle of the facets regular all around the cylinder. Without the guide marks from the decorating disk, it is common for the angle and/or width of the spiral facet to change as the potter proceeds around the cylinder.

Alternatively, marks do not need to be made at the bottom of the clay cylinder, and the wire tool can be drawn straight down from the top leaving vertical facets in the wall of the cylinder. Again, the marks made through the decorating disk at the top of the clay cylinder allow for precisely symmetrical faceting of the clay.

### EXAMPLE 3

### Altering a Freshly Thrown Shape

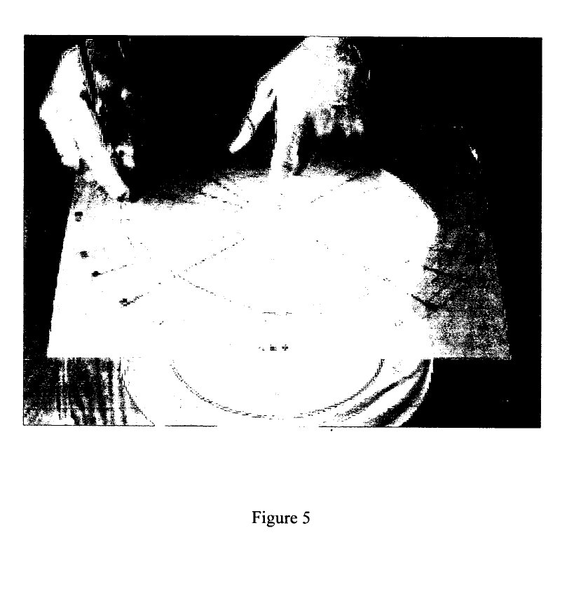

A wide rimmed bowl approximately 15 inches wide and 8 inches deep is formed using the standard techniques of a potter. While the clay is still very wet, a decorating disk is centered on the rim using the concentric lines marked on the disk. Using only 4 of the six-divisions radial lines, marks are made in the rim of bowl using a needle tool and poking it through the holes of the decorating disk to mark the 4 corners of a rectangle. The decorating disk is then lifted from the rim of the bowl, and a finger or round-ended dowel is used to pull the interior wall of the bowl to stretch out each corner of the rectangle. The marking and stretching process is shown in FIG. 5. The rim and walls of the bowl are in this manner stretched into the shape of a rectangle. The decorating disk is then again placed on the rim of the bowl and the corners of the now rectangular bowl are checked for accuracy and squareness and modified as needed.

Using the same technique, objects can be precisely altered into any regular-sided form. A similar process can be used to create a smooth oval shape.

### EXAMPLE 4

### Creating a Regular Symmetrical Square or Rectangular Foot

The thrown bowl from example three is allowed to dry to the point of being stiff enough to support its own weight (the leather-hard stage). Then it is turned upside down on a potter's wheel and centered as needed. A round foot is carved into the clay using various trimming tools. Once the basic circular foot has been carved into the clay, the decorating disk, marked with concentric circles and radial lines, is placed on the foot and centered using the concentric circles. Marks are then made in the still somewhat soft clay of the foot by using a needle tool to poke through the appropriate holes along the six-divisions radial lines of the decorating disk. The marks on the foot are aligned with the rectangular shape of the altered bowl. The clay foot is then carved away using a wire tool down to the bottom of the foot ring, and the remaining sections of the foot are pushed from the inside into a right angled wooden form, thus making rectangular foot elements to match the rectangular shape of the bowl.

### EXAMPLE 5

### Adding Sprig Decorations Symmetrically to a Thrown Form

A cylindrical vase 20 inches tall is formed using the standard techniques of a potter. When the clay is partially dried (the leather-hard stage), it is suitable for application of sprigs (small pieces of clay in a decorative shape formed in a plaster mold). The decorating disk, marked with concentric circles and radial lines, is centered on the rim of the vase using the concentric circles. The rim is marked by inserting a needle tool through the holes in the 10-divisions line nearest the rim. These marks are then used as guides in symmetrically placing the sprigs around the vase. If the sprigs are to be applied in, for example, a spiral pattern, the bottom of the object could also be marked, using the technique shown in example 2, and the sprigs applied to the form using both markings as a guide.

The same technique may be used for rapidly and precisely attaching any addition to a clay form.

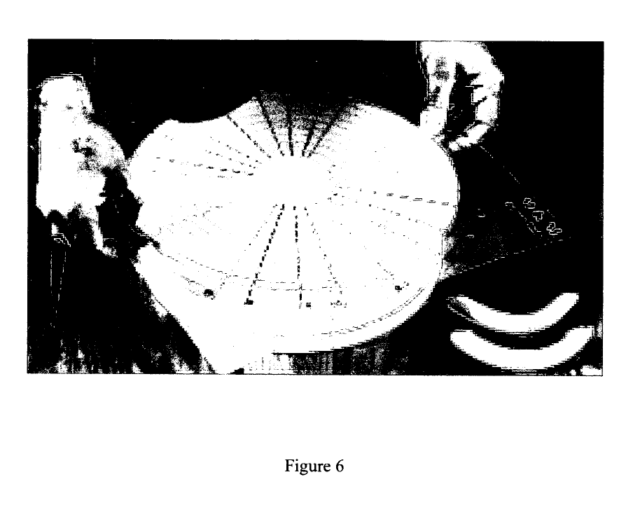

FIG. 6 shows locating the proper position to attach handles on a shallow bowl.

### EXAMPLE 6

### Geometric Slip Trailing on a Plate

A 12″ plate was prepared using the standard techniques of a potter. At the leather-hard stage when the clay is still somewhat soft, a decorating disk marked with concentric circles and radial lines was placed above the plate. Using the concentric rings, the disk was quickly centered above the plate. Using the 4-divisions lines, the plate was marked with a needle tool as close as possible to the rim. Removing the disk, a slip line was drawn between the needle marks, creating a regular square. The decorating disk was again centered on the plate and returned to its original position by lining up the 4-divisions lines with the corners of the slip square. A needle tool was used to mark the plate through alternate 8-divisions lines, as close as possible to the interior of the slip lines. Again, slip lines were drawn between the needle marks. By repeating this process until the innermost radial line of the decorating disk is reached, a series of smaller and smaller squares is made, each beginning at the middle of the next larger square.

A perfect spiral slip trailed decoration can be made by marking the plate as close as possible to the rim with a 10-divisions line, then steadily moving in one hole on each next 10-divisions line until the innermost concentric ring is reached. Slip can be trailed over the marks to create a perfect spiral.

The examples are intended to show the utility of the invention. They are not intended to be limiting.

1). A potter's tool comprising:
an operatively transparent, free-standing sheet marked in two dimensions which contains holes less than or equal to ¼″ in diameter through said sheet at the intersection of said marks.

2) The potter's tool of claim 1 in which said holes are less than 1/8 inch in diameter.

3) The potter's tool of claim 1 in which said sheet is plastic.

4) The potter's tool of claim 1 in which said two dimensional markings are in the form of a grid.

5) The potter's tool of claim 1 in which said two dimensional markings are in the form of concentric circles and radial lines.

6) The potter's tool of claim 1 in which said markings are printed onto the sheet.

7) A potter's tool comprising:
An operatively transparent, free-standing sheet marked with concentric circles and radial lines which contains holes through said sheet less than or equal to 1/4 inch at the intersection of said lines.

8) The potter's tool of claim 7 in which said holes are less than 1/8 inch.

9) The potter's tool of claim 7 in which said sheet is plastic.

10) The potter's tool of claim 7 in which said markings are printed.

11) The potter's tool of claim 7 in which said radial lines mark off a series of equal increments.

12) The potter's tool of claim 7 in which said radial lines mark sets of divisions of the concentric circles.

13) The potter's tool of claim 12 in which said divisions are 4, 6, 8, and 10

14) The potter's tool of claim 12 in which said divisions are 3, 5, 7, and 9

15) The potter's tool of claim 12 in which said radial lines are colored to indicate the particular series of increments.

16) The potter's tool of claim 12 in which said radial lines have indicia to indicate the particular series of increments.

17) A method for providing a system to rapidly and precisely apply geometric decoration to clay object comprising:
An operatively transparent, free-standing sheet marked with concentric circles and radial lines which contains holes through said sheet less than or equal to 1/4 inch at the intersection of said lines; and instructions for its use.

18) The method of claim 17 in which said holes in said sheet are less than 1/8 inch in diameter.

19) The method of claim 17 in which said sheet is 3/32 inch mylar.

20) The method of claim 17 in which said radial lines on said sheet mark off a series of equal increments.

21) The method of claim 17 in which said radial lines on said sheet mark sets of divisions of the concentric circles.

22) The method of claim 21 in which said divisions are 4, 6, 8, and 10.

23) The method of claim 21 in which said divisions are 3, 5, 7, and 9.

24) The method of claim 21 in which said radial lines are colored to indicate the particular series of increments.

25) The method of claim 21 in which said radial lines have indicia to indicate the particular series of increments.

26) The method of claim 17 in which said sheet is placed above clay object to be marked.

27) The method of claim 17 in which said sheet is placed below clay object to be marked.

28) The method of claim 17 in which said sheet is placed within clay object for marking.
